(19) United States
(12) Patent Application Publication
(10) Pub. No.: US 2015/0125341 A1
(43) Pub. Date: May 7, 2015

(54) Non-Rare Earth Magnets Having Manganese (MN) and Bismuth (BI) Alloyed with Cobalt (CO)

(71) Applicant: THE BOARD OF TRUSTEES OF THE UNIVERSITY OF ALABAMA FOR AND ON BEHALF OF THE UNIVERSITY OF ALABAMA, Tuscaloosa, AL (US)

(72) Inventors: Yang-Ki Hong, Tuscaloosa, AL (US); Jihoon Park, Tuscaloosa, AL (US)

(21) Appl. No.: 14/394,976

(22) PCT Filed: Apr. 16, 2013
(86) PCT No.: PCT/US13/36772

§ 371 Date: Oct. 16, 2014

Related U.S. Application Data
(60) Provisional application No. 61/624,817, filed on Apr. 16, 2012.

(51) Int. Cl. H01F 1/047; C22C 1/00; C22C 22/00

(52) U.S. Cl. CPC H01F 1/047; C22C 22/00; C22C 1/00
USPC 420/434; 75/392

(57) ABSTRACT

Permanent and soft magnets that do not depend on rare-earth elements have suitable magnetic properties for electric motor and generator applications. Both saturation magnetization and magneto-crystalline anisotropy of a manganese-bismuth (Mn—Bi) permanent (hard) magnet are increased by alloying the Mn—Bi magnet with cobalt (Co) or cobalt-iron (Co—Fe). Such magnets do not include rare-earth and precious metals (e.g., platinum), which are expensive and often limited in supply, but offer high magneto-crystalline anisotropy and magnetization. Therefore, a relatively high maximum energy product (BH)ₘₐₓ is achieved.

This is the national stage application of and claims priority to International Application No. PCT/US2013/036772, entitled “Non-Rare Earth Magnets having Manganese (Mn) and Bismuth (Bi) Alloyed with Cobalt (CO)” and having an international filing date of Apr. 16, 2013, which is incorporated herein by reference. International Application No. PCT/US2013/036772 claims priority to U.S. Provisional Patent Application No. 61/624,817, entitled “Non-Rare Earth Magnets having Manganese (Mn) and Bismuth (Bi)” and filed on Apr. 16, 2012, which is incorporated herein by reference.

### RELATED ART

There are several issues to address to efficiently and reliably use permanent magnets in electric vehicles, windmill generators, and other electric motor applications. One issue is the low operational temperature range of conventional magnets. In this regard, rare-earth magnets, including Nd₂Fe₁₄B, Dy-doped Nd₂Fe₁₄B, SmCo, and Sm₂Fe₁₇N₃, have been used or considered for use in motors for hybrid and electric vehicles. Of these magnets, Nd₂Fe₁₄B generally possesses the highest maximum energy product (BH)ₘₐₓ of around 59 MGOe. See, S. Sugimoto, J. Phys. D: Appl. Phys., Vol. 44, 064001 (2011). However, the operational temperature of this magnet is limited to around 150° C., which is attributable to a low Curie temperature of around 250° C. See T. Akiya, et al., Mat. Sci. and Eng., Vol. 1, 012034 (2009). Furthermore, magnetization and coercivity rapidly decrease with temperature, and (BH)ₘₐₓ approaches about 5 MGOe at about 250° C. Thus, there is a loss of magnetic properties as the operating temperature increases, and this magnetic property loss could lead to motor failure. In order to increase the operational temperature, Dy and Pr have been added to Nd₂Fe₁₄B. These additions increase coercivity, but decrease the magnetization, and the temperature coefficient of coercivity (DH_{c}/DT) still remains high.

In addition, many conventional magnets for electric motor applications utilize rare-earth elements, which are scarce and expensive. Further, much of the deposits of rare-earth elements are found in China. Generally, in order to reduce costs, as well as dependency on China as a supplier of rare-earth elements, it is desirable to find suitable alternatives that do not require the use of rare-earth elements, yet provide desirable magnetic properties for electric motor and generator applications. Indeed, over the last decade, significant effort has been expended to find suitable magnets that do not depend on rare-earth elements.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 depicts a crystal structure of a conventional Manganese-bismuth (Mn—Bi) magnet.

FIG. 2 shows the Mn—Bi magnet of FIG. 1 after alloying with Co to form a Manganese-Bismuth-Cobalt (Mn—Bi—Co) magnet.

FIG. 3 shows the density of states (DOS) for the Mn—Bi magnet shown by FIG. 1.

FIG. 4 shows the DOS for the Mn—Bi—Co magnet shown by FIG. 2.

FIG. 5 shows a magnetic spin configuration for <100>direction for the Mn—Bi—Co magnet of FIG. 2.

FIG. 6 shows a magnetic spin configuration for <310>direction for the Mn—Bi—Co magnet of FIG. 2.

FIG. 7 shows a ferromagnetic spin configuration for the Mn—Bi—Co magnet of FIG. 2.

FIG. 8 shows an antiferromagnetic spin configuration for the Mn—Bi—Co magnet of FIG. 2.

FIG. 9 shows a crystal structure of the Mn—Bi magnet of FIG. 1 after alloying with Co and Fe.

FIG. 10 shows the DOS for the Mn—Bi—Co—Fe magnet shown by FIG. 9.

FIG. 11 shows a table of exemplary magnetic data at 0 K for a Mn—Bi magnet, a Mn—Bi—Co magnet, and a Mn—Bi—Co—Fe magnet.

FIG. 12 shows an exemplary method of forming a metallic magnet (e.g., Mn—Bi—Co or Mn—Bi—Co—Fe) using directional solidification.

FIG. 13 shows an exemplary method of forming a metallic magnet (e.g., Mn—Bi—Co or Mn—Bi—Co—Fe) using arc melting.

FIG. 14 shows an exemplary method of forming a metallic magnet (e.g., Mn—Bi—Co or Mn—Bi—Co—Fe) using mechanical alloying.

FIG. 15 shows an exemplary method of forming a metallic magnet (e.g., Mn—Bi—Co or Mn—Bi—Co—Fe) using sputter deposition.

FIG. 16 shows an exemplary method of forming a metallic magnet (e.g., Mn—Bi—Co or Mn—Bi—Co—Fe) using electron beam evaporation.

FIG. 17 shows an exemplary method of forming a metallic magnet (e.g., Mn—Bi—Co or Mn—Bi—Co—Fe) using pulsed laser deposition.

FIG. 18 shows an exemplary method of forming a metallic magnet (e.g., Mn—Bi—Co or Mn—Bi—Co—Fe) using sintering and milling.

### DETAILED DESCRIPTION

The present disclosure generally pertains to permanent and soft magnets that do not depend on rare-earth elements and have suitable magnetic properties for various applications, such as electric motor and generator applications. In one exemplary embodiment, both saturation magnetization and magneto-crystalline anisotropy of a manganese-bismuth (Mn—Bi) permanent (hard) magnet are increased by alloying the Mn—Bi magnet with cobalt (Co) or cobalt-iron (Co—Fe). Such metallic alloy magnets do not include rare-earth and precious metals (e.g., platinum), which are expensive and often limited in supply, but offer high magneto-crystalline anisotropy and magnetization. Therefore, a relatively high maximum energy product (BH)ₘₐₓ is achieved. For example, a Mn—Bi—Co magnet has a higher operation temperature than that of Nd(Dy, Pr)₂Fe₁₄B permanent magnet and can be used up to at least 250° C., which is higher than the operational temperature range of many conventional electrical motors and generators.

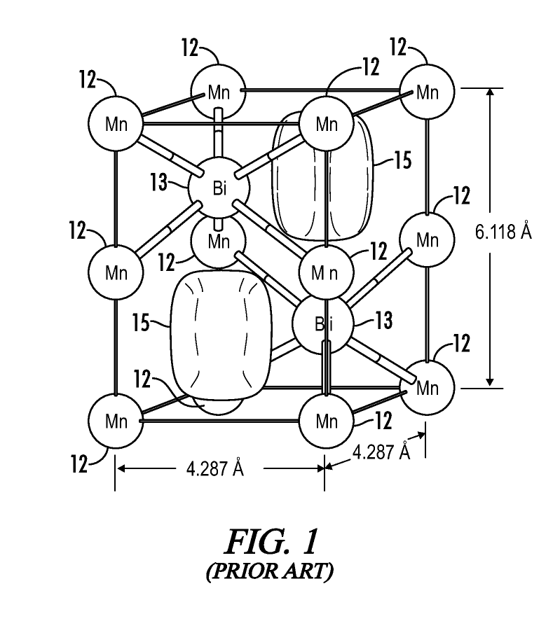

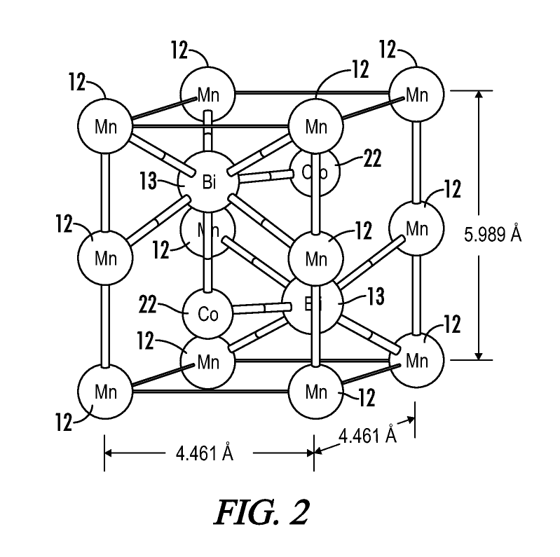

In one exemplary embodiment, a conventional Mn—Bi permanent magnet is alloyed with Co to provide a high (BH)ₘₐₓ Mn—Bi—Co permanent magnet. FIG. 1 depicts a crystal structure of a conventional Mn—Bi magnet having Mn atoms 12 and Bi atoms 13 arranged as shown. The volume of the lattice structure of FIG. 1 is about 97 angstroms³ (Å³). Interstitial spaces 15 are available for occupation by Co atoms when the Mn—Bi magnet is alloyed with Co. In this regard, FIG. 2 shows the Mn—Bi magnet of FIG. 1 after alloying with Co causing Co atoms 22 to occupy the spaces 15 resulting in an increase in magnetization and magneto-crystalline anisotropy. The volume of the lattice structure of FIG. 2 is about 103 Å³. Notably, the material phase of the Mn—Bi—Co magnet is metallic.

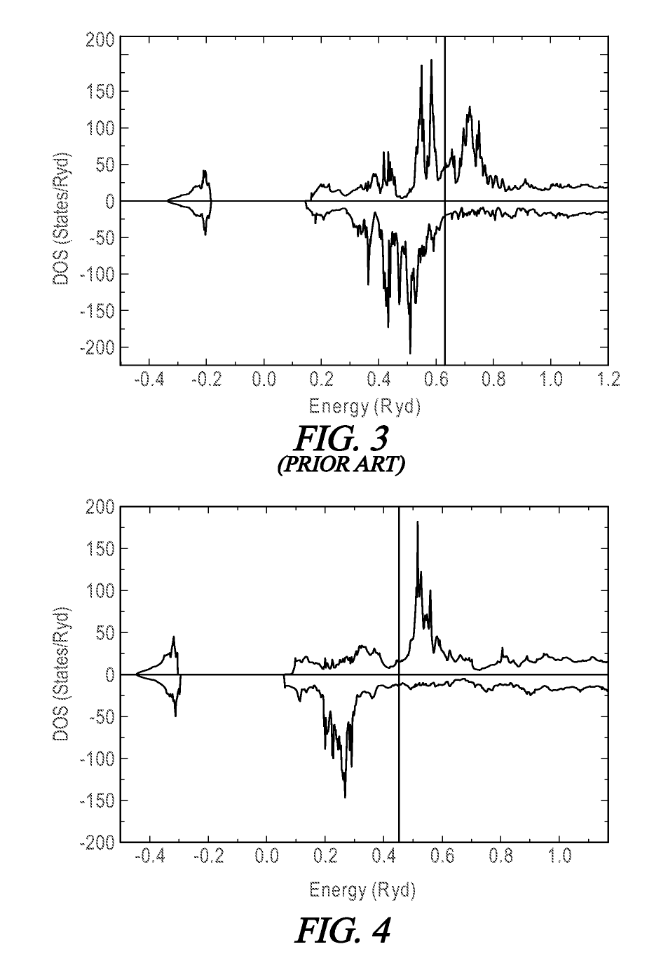

FIG. 3 shows the density of states (DOS) for the Mn—Bi magnet shown by FIG. 1, and FIG. 4 shows the DOS for the Mn—Bi—Co magnet shown by FIG. 2. The DOS shown by FIG. 3 and the DOS shown by FIG. 4 were used to calculate magnetization of the Mn—Bin magnet and the Mn—Bi—Co magnet, respectively, as will be described in more detail below, using density functional theory (DFT: first-principles calculation).

The difference between integrated spin-up and spin-down DOS was taken as the magnetic moment per unit cell. Magnetic moment at 0 Kelvin (K) was calculated to be about 3.63 μ_{B}f.u. for the conventional Mn—Bi magnet shown by FIG. 1 and about 4.59 μ_{B}f.u.for the Mn—Bi—Co magnet shown by FIG. 2. In addition, magnetization at room temperature was estimated by combining the DOS data with the Brillouin function. The estimated magnetizations are about 0.82 and about 0.94 Tesla for the conventional Mn—Bi magnet and the Mn—Bi—Co magnet, respectively.

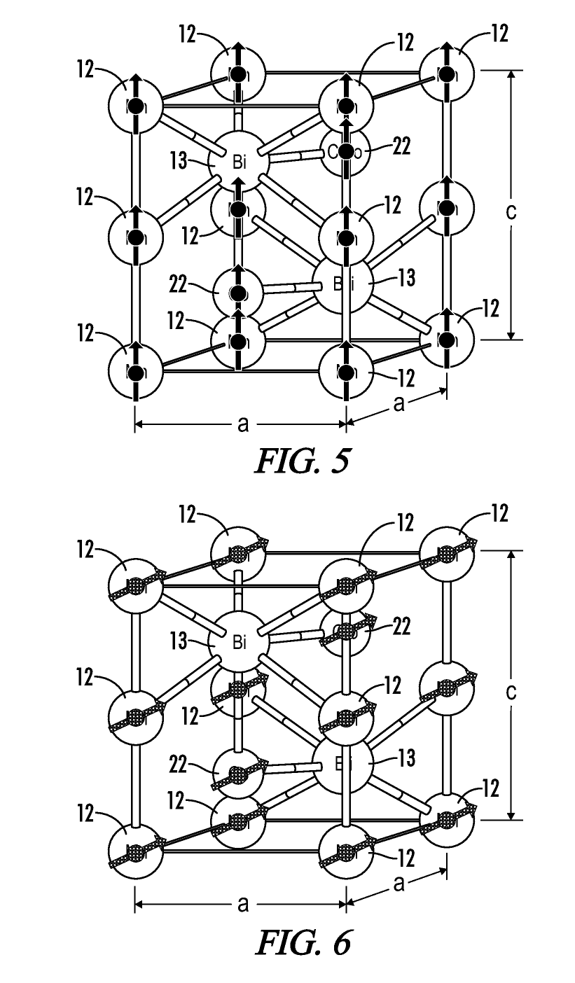

In order to predict the magneto-crystalline anisotropy of the Mn—Bi—Co magnet, the total energy for <100>magnetic spin configuration shown by FIG. 5 and the total energy for <310>magnetic spin configuration shown by FIG. 6 were calculated. The difference between the total energies represents a uniaxial magneto-crystalline anisotropy energy, which is about 4.75 meV/u.c. at 0 K. This energy corresponds to about 7.38×10⁶ Joules per cubic meter (J/m³) of magneto-crystalline anisotropy constant (Ku) of the Mn—Bi—Co magnet.

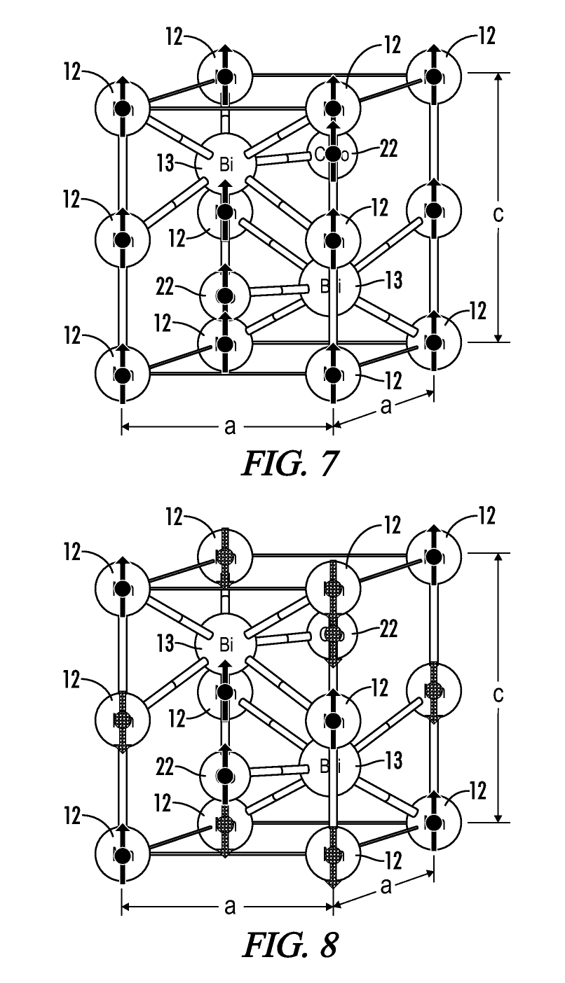

With regard to the Curie Temperature (T_{c}), the ferromagnetic spin configuration shown by FIG. 7 and the antiferromagnetic spin configuration shown by FIG. 8 were used to calculate the energy difference between the two spin configurations of the Mn—Bi—Co magnet. The energy difference was calculated to be about 155 meV/u.c., which corresponds to about 327 degrees Celsius (° C.) of the T_{c}. The T_{c} was obtained by dividing the energy difference by 3k_{B}T, where k_{B} is the Boltzmann constant T is temperature.

As a result, magneto-crystalline anisotropy increased from about 1.8×10⁶ J/m³ of the Mn—Bi magnet to about 7.38×10⁶ J/m³ at 0 K for the Mn—Bi—Co magnet, while the Curie temperature decreased to about 327° C. from about 355° C. [Y. Liu, Current Applied Physics, Vol. 7, 555 (2007)] of the Mn—Bi magnet. Accordingly, theoretical limits of (BH)ₘₐₓ were estimated to be about 16.8 MGOe for the conventional Mn—Bi magnet and about 22.1 MGOe for the Mn—Bi magnet alloyed with Co. It is evident that addition of Co to the conventional Mn—Bi magnet enhanced magnetization and magneto-crystalline anisotropy and, hence, increased the maximum energy product (BH)ₘₐₓ.

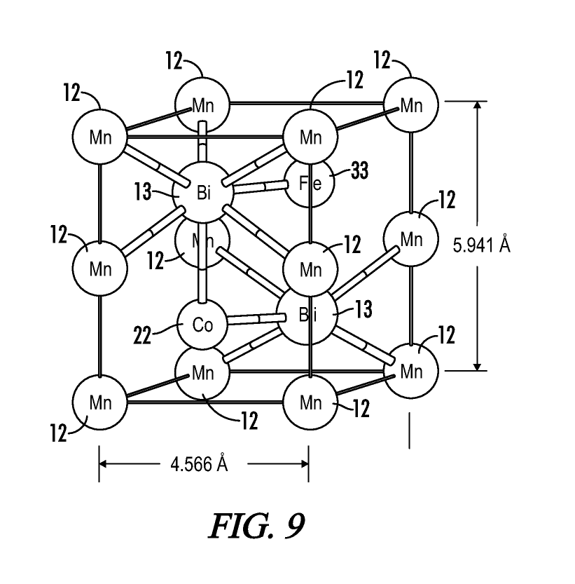

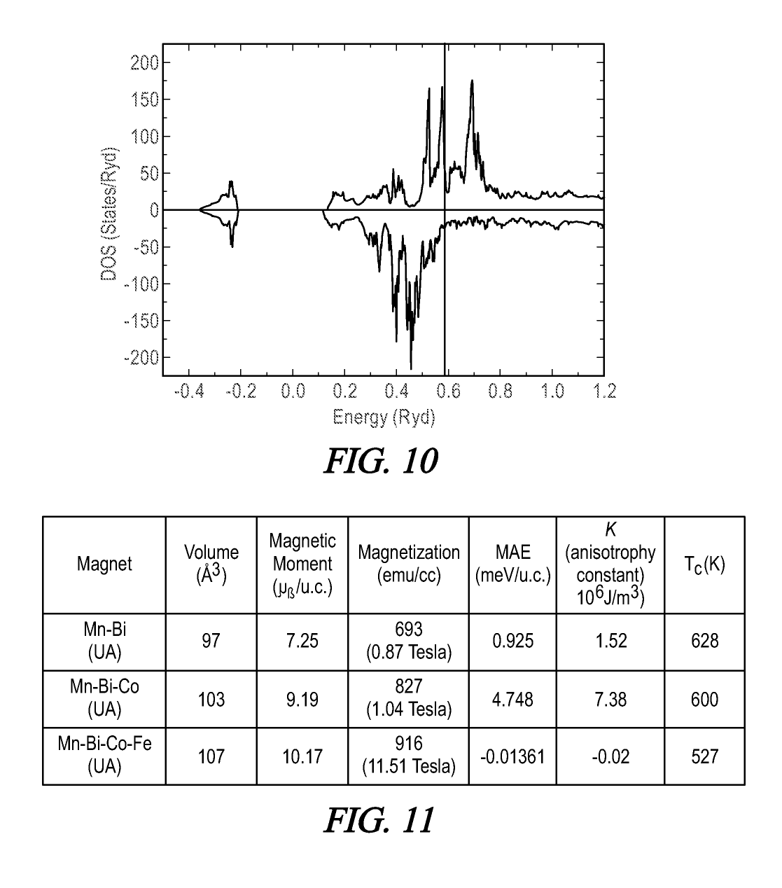

In one exemplary embodiment, iron (Fe) is added to the metallic magnet of Mn—Bi—Co described above in order to make it magnetically soft. FIG. 9 shows the Mn—Bi—Co magnet of FIG. 1 after alloying with Co and Fe causing a Co atom 22 to occupy a space 15 and an Fe atom to occupy another space 15 resulting in a magnetically soft material having an increase in magnetization and magneto-crystalline anisotropy. FIG. 10 shows the DOS for the Mn—Bi—Co—Fe magnet shown by FIG. 9. The DOS shown by FIG. 10 was used to calculate magnetization of the Mn—Bi—Co—Fe magnet, as will be described in more detail below, using density functional theory (DFT: first-principles calculation).

Based on the calculations described above, magnetization increased from about 693 emu/cm³ (about 0.87 Tesla) for the conventional Mn—Bi magnet to about 963 emu/cm³ (1.21 Tesla) for the Mn—Bi—Co—Fe magnet, while the magneto-crystalline anisotropy constant decreased to about −2×10⁴ J/m³ at 0 K from about 1.8×10⁶ J/m³ at room temperature [X. Guo, et al., Phys. Rev. B, Vol. 46, 14578 (1992)]. Therefore, it is evident that a Mn—Bi—Co—Fe magnet is magnetically softer than a Mn—Bi magnet and a Mn—Bi—Co magnet.

A summary of magnetic data at 0 K for a Mn—Bi magnet, a Mn—Bi—Co magnet, and a Mn—Bi—Co—Fe magnet is shown by FIG. 11. As shown by FIG. 11, alloying a conventional Mn—Bi magnet with Co can increase magneto-crystalline anisotropy by about 386%, while the magnetization increases by about 19%. Therefore, a Mn—Bi—Co magnet exhibits a much higher maximum energy product than a conventional Mn—Bi magnet. Furthermore, alloying a Mn—Bi—Co magnet with Fe increases the magnetization by about 32%, while the magneto-crystalline anisotropy constant decreases to −2×10⁴ Jm³ from about 1.52×10⁶ J/m³. This is a two orders of magnitude decrease in magneto-crystalline anisotropy. Therefore, Mn—Bi—Co—Fe becomes a soft magnet, and the Curie temperature decreases with alloying elements.

It should be noted that there are various techniques that can be used to form the metallic magnets (e.g., Mn—Bi—Co and Mn—Bi—Co—Fe) described herein. Exemplary techniques for forming such metallic magnets will be described in more detail below.

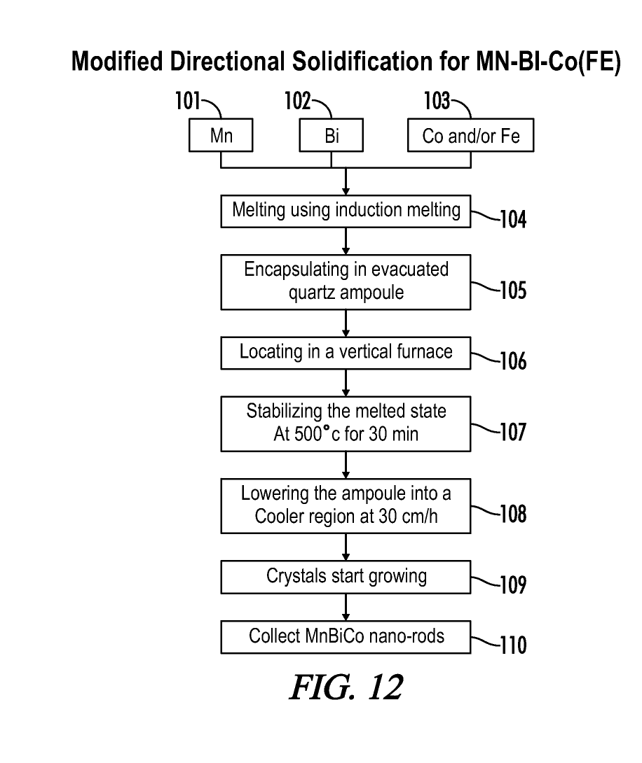

In one exemplary embodiment, directional solidification similar to the techniques described in U.S. Pat. No. 4,784,703, which is incorporated herein by reference, is used to form the metallic magnets. In this regard, Mn and Bi, as well as Co and/or Fe, are melted using induction melting, as shown by blocks 101-104 of FIG. 12. The melted material is then encapsulated in an evacuated quartz ampoule, which is positioned in a vertical furnace, as shown by blocks 105 and 106 of FIG. 12. The melted state is then stabilized at about 500° C. for about 30 minutes, as shown by block 107. The ampoule is then lowered into a cooler region at about 30 cm per hour and crystals begin growing to form magnetic nano-rods, which can be later collected, as shown by blocks 108-110.

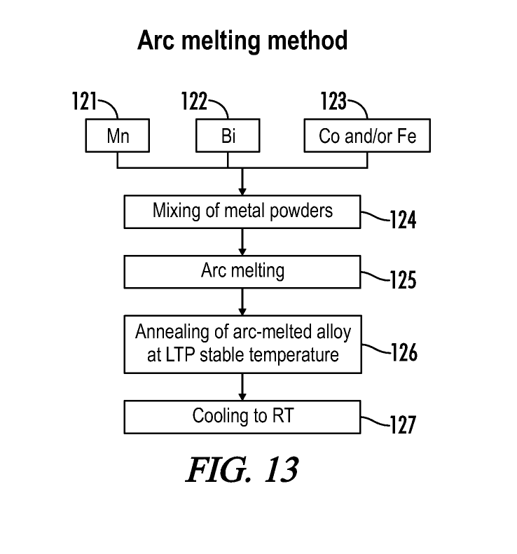

In another exemplary embodiment, powders of Mn and Bi, as well as Co and/or Fe, are mixed and then arc-melted, as shown by blocks 121-125 of FIG. 13. The arc-melted alloy is then annealed, as shown by block 126, and cooled to room temperature (RT), as shown by block 127.

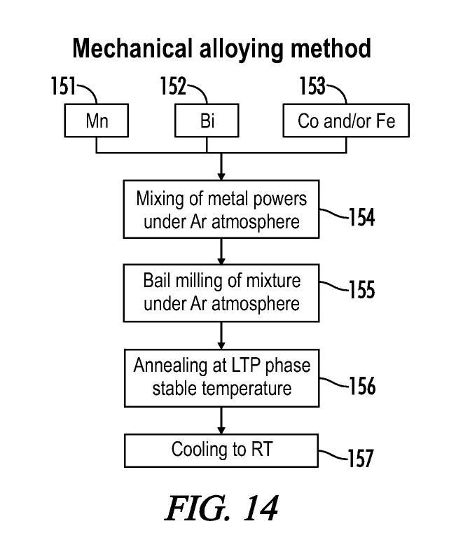

In yet another exemplary embodiment, powders of Mn and Bi, as well as Co and/or Fe, are mixed and ball milled under Ar atmosphere, as shown by blocks 151-157 of FIG. 14. The material is then annealed, as shown by block 156, and cooled to room temperature, as shown by block 157.

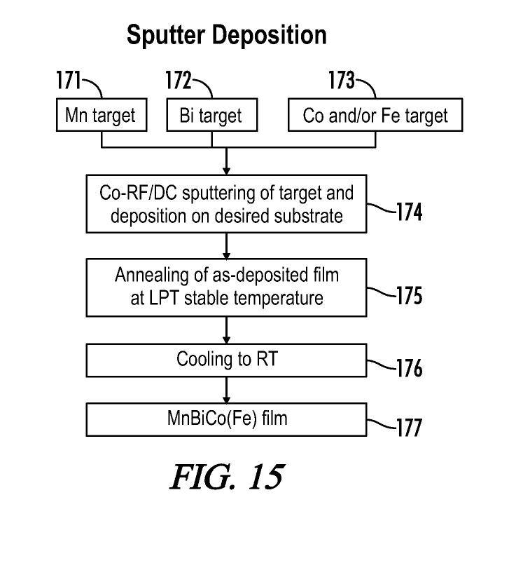

In one exemplary embodiment, Mn and Bi, as well as Co and/or Fe, are sputtered and deposited on a substrate, as shown by blocks 171-174 of FIG. 15. The material is then annealed and cooled to room temperature, thereby providing a magnetic film as shown by blocks 175-177.

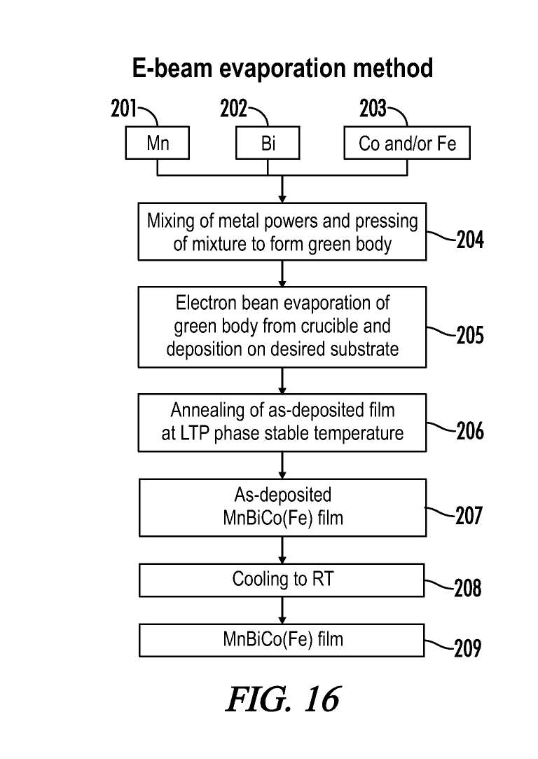

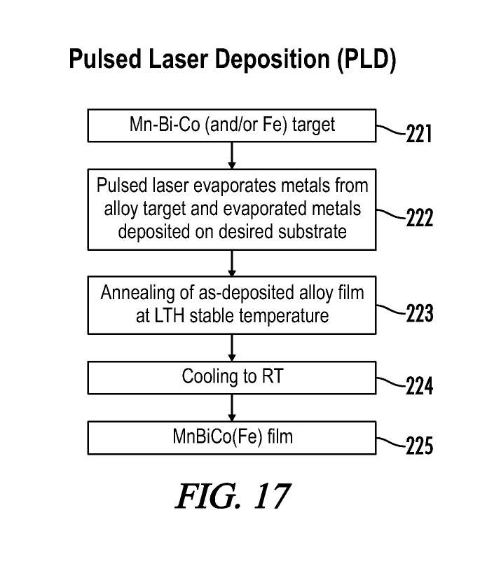

In another exemplary embodiment, Mn and Bi, as well as Co and/or Fe, are mixed and pressed to form a green body, as shown by blocks 201-204 of FIG. 16. The green body is then evaporated via electron beam evaporation and deposited on a substrate, thereby forming a deposited film, as shown by blocks 205 and 206. The deposited film is then annealed and cooled to room temperature, thereby providing a magnetic film of Mn—Bi—Co or Mn—Bi—Co—Fe, as shown by blocks 207-209.

In yet another exemplary embodiment, Mn and Bi, as well as Co and/or Fe, are evaporated using a pulsed laser and deposited on a substrate, as shown by blocks 221 and 222. The material is then annealed and cooled to room temperature, thereby providing a magnetic film, as shown by blocks 223-225.

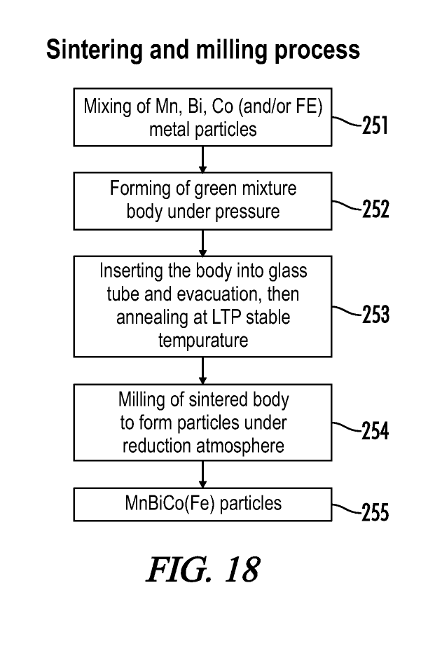

In one exemplary embodiment, particles of Mn and Bi, as well as Co and/or Fe, are mixed and pressed to form a green body, as shown by blocks 251-252 of FIG. 18. The green body is then inserted into a glass tube, which is evacuated, and the material is annealed, as shown by block 253. The sintered body is then milled to form particles under reduction atmosphere, thereby providing magnetic particles, as shown by blocks 254 and 255.

The techniques described above for forming metallic magnets are exemplary, and other techniques may be used in other embodiments.

The magnetic material described herein may be used in a variety of applications.

As an example, the magnetic material may be used as an electrode for a perpendicular-anisotropy magnetic tunneling junction (p-MTJ) or a perpendicular-anisotropy magnetic random access memory (p-MRAM). The material of an electrode for a p-MTJ or p-MRAM may be (1) Mn—Bi, (2) Mn—Bi—X (where X is selected from the group including: Co, Fe, Pt, Cu, Au, Al, Ag, Se, Si, Ge, Ni, Ga, Zn, and In), (3) Mn—Bi—Co—Y (where Y is selected from the group including: Fe, Pt, Cu, Au, Al, Ag, Se, Si, Ge, Ni, Ga, Zn, In)/MgO/Mn—Bi—Co—Z (where Z is selected from the group including: Fe, Pt, Cu, Au, Al, Ag, Se, Si, Ge, Ni, Ga, Zn, In), or (4) Mn—Bi—Co-V (where V is selected from the group including: Fe, Pt, Cu, Au, Al, Ag, Se, Si, Ge, Ni, Ga, Zn, In). The material of a stack for a p-MTJ may be Mn—Bi—Co/MgO/Mn—Bi—Co/AFM (any Antiferromagnetic material), and a stack for a p-MTJ or MRAM may be Mn—Bi-U/MgO/Mn—Bi-U/AFM (where U is selected from the group including: Co, Fe, Pt, Cu, Au, Al, Ag, Se, Si, Ge, Ni, Ga, Zn, In). In other embodiments, yet other materials are possible

Now, therefore, the following is claimed:

1. A magnetic alloy, comprising:
manganese (12);
bismuth (13); and
cobalt (22),
wherein a material phase of the alloy is metallic.

2. The metallic alloy of claim 1, wherein the metallic magnetic material is free of rare-earth metals

3. The metallic alloy of claim 1, further comprising iron.

4. The metallic alloy of claim 3, wherein the metallic alloy is free of rare-earth metals.

5. A method, comprising:
forming a magnet having a material phase that is metallic,
wherein the forming comprises alloying manganese (12), bismuth (13), and cobalt (22).

6. The method of claim 5, wherein the magnet is free of rare-earth metals.

7. The method of claim 5, wherein the forming further comprises alloying iron with the manganese, bismuth, and cobalt.

8. The method of claim 6, wherein the magnet is free of rare-earth metals.
